(19) United States
(12) Patent Application Publication
(10) Pub. No.: US 2009/0049977 A1
(43) Pub. Date: Feb. 26, 2009

(54) SINGLE HOLED FLUTE

(76) Inventor: STEVE WELLS, Lakewood, CO (US)

Correspondence Address: MICHAEL RIES, 318 PARKER PLACE, OSWEGO, IL, 60543, US

(21) Appl. No.: 12/032,694

(22) Filed: Feb. 17, 2008

Related U.S. Application Data
(60) Provisional application No. 60/968,075, filed on Aug. 26, 2007.

(51) Int. Cl. G10D 7/02

(52) U.S. Cl. 84/384

(57) ABSTRACT

What is disclosed is a musical instrument that may be a single holed flute that has the tonal characteristics of a flute, but offers an infinite scale of available notes and pitch modification between the high and low limits of the single holed flute's tone production.

This application claims priority to U.S. Provisional Application 60/968,075 filed Aug. 26, 2007, the entire disclosure of which is incorporated by reference.

### TECHNICAL FIELD & BACKGROUND

The present invention generally relates to the field of musical instruments. More specifically, the present invention relates to a single holed flute that has the tonal characteristics of a flute, but offers an infinite scale of available notes and pitch modification between the high and low limits of the single holed flute's tone production.

The present invention affords the player a much wider range of musical expression normally only found on other instruments on which notes can easily ‘bend’, ‘slide’, and seamlessly ‘glissando’. With this enhanced expressive potential, styles of music not often played on the flute such as blues and jazz can be much more flexibly played. On other devices the most practical form of ‘vibrato’, or modulation of the pitch of a note, on conventional flutes is created by varied application of the breath, on the single holed flute of the present invention, a manual form of vibrato can be applied that is very precisely variable and expressive.

The present invention flute would be considered a member of the flute family of musical instruments by virtue of the fact that wind from the breath is channeled across an small opening at the end of a tube and into a cutting edge which splits the air stream precisely, in such a way that a sound, or musical tone is produced.

Also characteristic of the flute family, the pitch of the sound is augmented manually by varying the shape and active length of the air column formed within the length of the flute tube.

These characteristics can be found in one form or another in all members of the flute family, yet beyond these basics the present invention instrument differs in many ways. Though the sound creation mechanism on the present invention flute could be termed a ‘fipple’, as the air stream is shaped by constraining fixtures within the flute, as opposed to the air stream being formed by the lips of the player, it does not use a conventional windway or ‘flue’ of some length to shape the air stream to appropriately attack the cutting edge that produces the tone.

Instead, the present invention uses a principle found in fluid dynamics that dictates that an even fluid pressure against a flat plate perpendicular to the pressure force, and allowed to escape through an orifice that has a minimal channel length (theoretically zero), will create a fluid stream that is virtually free of turbulence.

This freedom from turbulence in turn ensures that the air stream hitting the cutting edge of the flute is as pure and efficiently employed to generate the tone intended, with as little extraneous, non-tone-producing wind sounds as possible. In addition to this efficient and precise method of deploying the air stream in the present invention, there are other advantages of this configuration as well.

Traditionally, flutes that use a fipple (or an air stream shaping channel), suffer from the characteristic of becoming clogged with condensed moisture after a period of the instrument being played. In the case of the penny whistle, the European recorder, and the Native American flute, this can reach a point where continued playing is impossible without taking measures to clear the windway of moisture.

With the ‘Flat Plate Orifice’ method that this new design employs in the present invention, it is nearly impossible to impede the negligible length windway with moisture, as any moisture that forms there is quickly passed through before having the opportunity to collect substantially. The open design of the blowing end of this flute allows any moisture that does accumulate upstream of the sound mechanism to be easily wiped away with a small piece of cloth over one's finger.

Unlike other members of the flute family, pitch on the present invention instrument is not altered by placing or removing one's fingers off of pre-tuned holes to change the length of the air column.

Instead, pitch is altered on the present invention by either closing or opening to varying degrees with one's hand, a single ovular hole several inches in length. Thus the extent of the pitch varies from it's lowest, with the ovular hole entirely covered, to it's highest, with one's hand totally off of the hole. Incremental pitches are obtained by varying the coverage of the hole by one's hand. As currently designed, this gives a musical range of 1.5 octaves or more.

With the above configuration of the present invention, a tube of consistent diameter, with no blockage in it's length, will offer about one octave of pitch change before the air stream jumps to the next harmonic register. The intent of the instrument design of the present invention is to provide a sliding scale of as great a scalar range as possible without shifting registers.

In order to extend the range of the present invention instrument beyond the one octave range, a bore-restricting triangular or vented block is placed in the distal end of the tube, which in effect lowers the lowest pitch producible, without lowering the highest pitch producible, extending the scalar range of the instrument to it's current 1.5 octaves.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a perspective view of a flute, in accordance with one embodiment of the present invention; and

FIG. 2 illustrates a side view of a flute, in accordance with one embodiment of the present invention;

FIG. 3 illustrates a side insert view of a flute, in accordance with one embodiment of the present invention; and

FIG. 4 illustrates a end view of a flute, in accordance with one embodiment of the present invention;

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

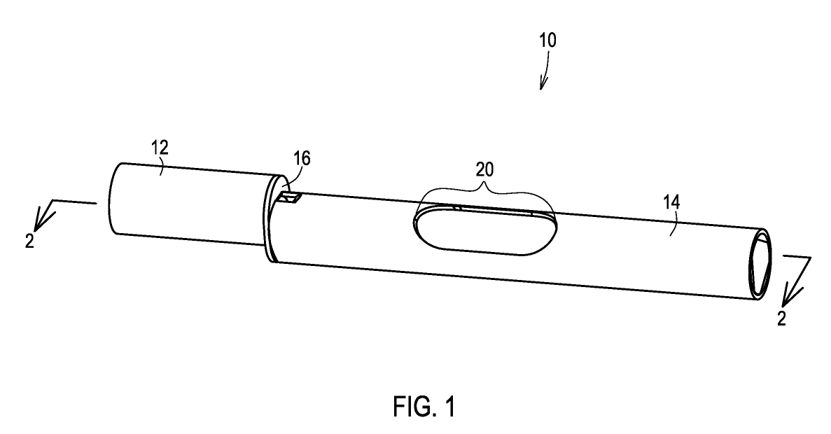

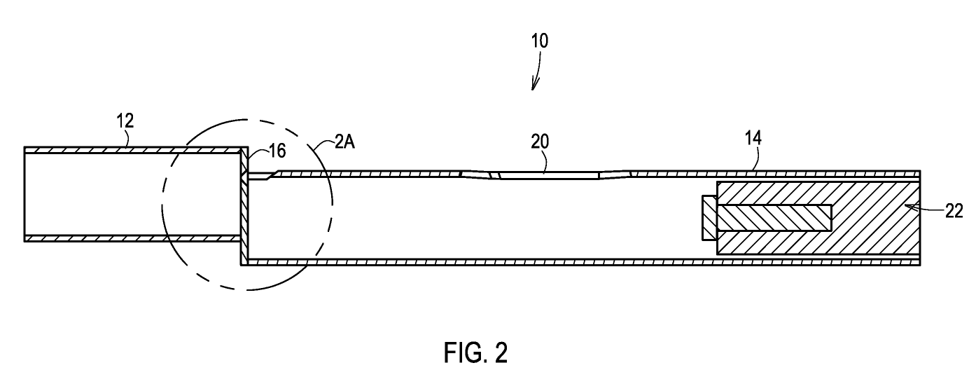

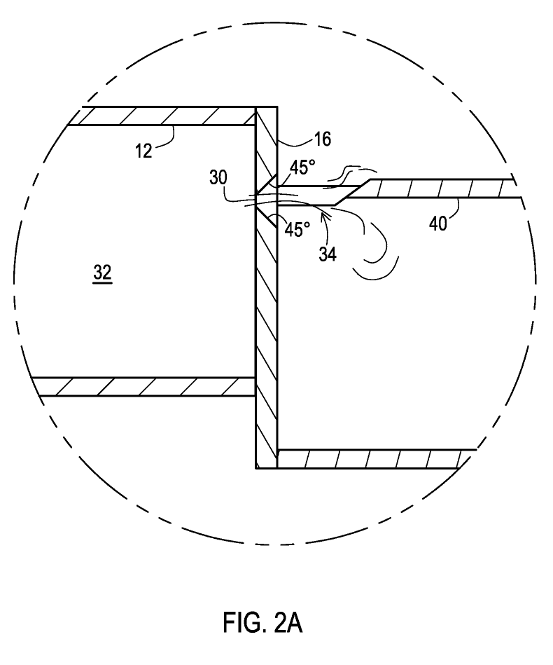

Referring now to FIG. 1, illustrated is a flute 10 with a mouth end 12 and an aft end 14. Shown is a flat plate 16 and hand or palm hole 20. The flat plate 16 is sandwiched between mouth end 12 and aft end 14. Referring to FIG. 2, as in the present invention, show is an aft block 22 that may be weighted and in a triangular shape. The palm hole 20 and flat plate 16 are also shown.

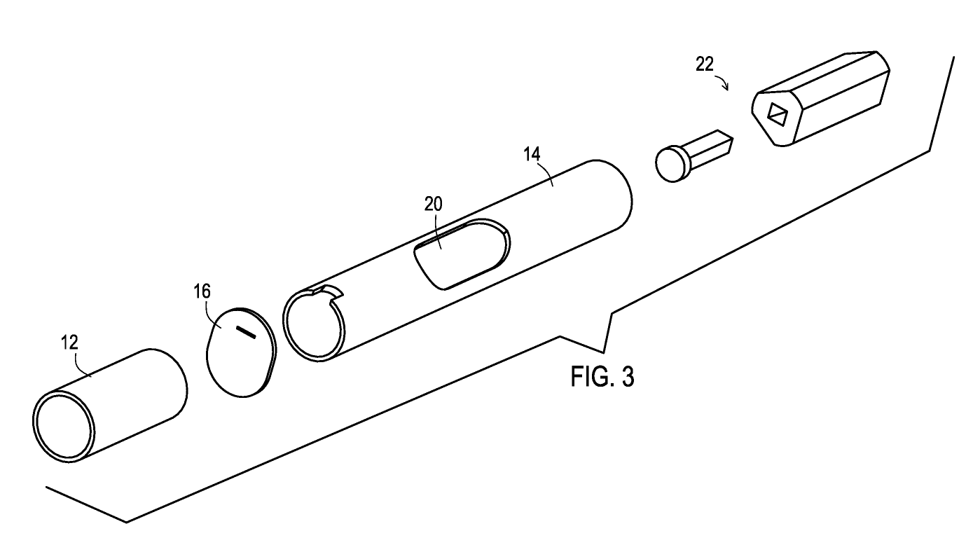

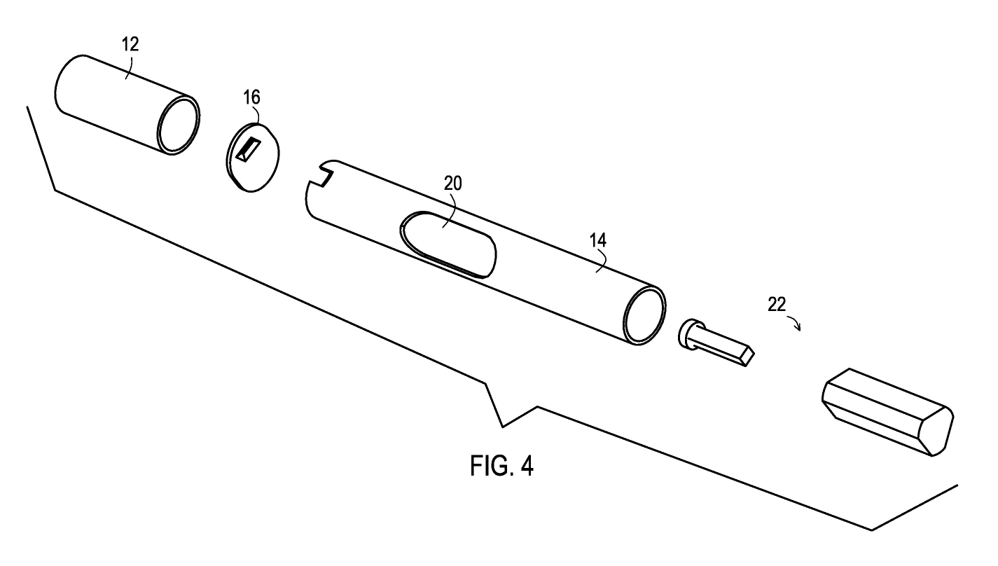

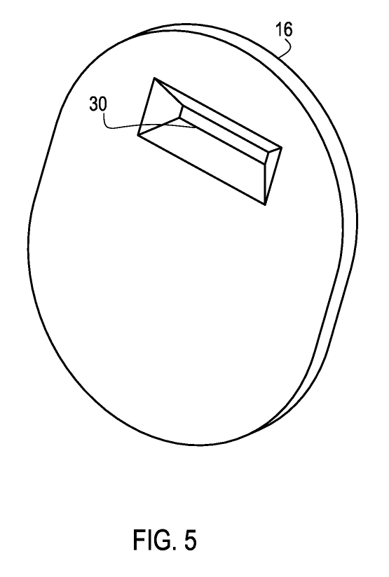

Referring to FIG. 3 as in one embodiment of the present invention, shown is the mouth end 12 with flat plate 16 attached. Flat plate 16 has a flat plate orifice 30, air pressure 32 builds up in the mouth end 12 and produces an air stream 34 that passes through flat plate orifice 30. Flat plate orifice 30 may be cut on a forty five degree angle. A cutting edge 40 of the aft end 14 will split the air stream 34. Referring to FIG. 4, as in the present invention shows flat plate 16, flat plate orifice 30 and aft end 14.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a mouth piece
a flat plate attached to the mouth piece; and
an aft piece attached to the flat plate.

2. The device of claim 1 wherein the flat piece has a flat plate orifice.

3. The device of claim 1 wherein the flat piece has a flat plate orifice with side walls on a forty five degree angle.

4. The device of claim 1 wherein the aft piece has a palm hole on the top of the aft piece.

5. The device of claim 1 wherein the aft piece has an aft block inserted into the aft piece.

6. A method comprising:
placing a user's hand over a palm hole;
blowing air into a mouth end of a single holed flute to create an air stream; and
moving the hand over the palm hole to make a manual form of vibrato as the air stream exits the palm hole.

7. The method of claim 6 wherein the user will only place the palm of the hand over the palm hole.

8. The method of claim 6 wherein the manual form of vibrato can be applied in a very precisely variable and expressive way by moving the hand over the palm hole.

9. The method of claim 6 wherein pitch is altered by either closing or opening to varying degrees with one's hand, a single ovular hole several inches in length

10. A device comprising:
a mouth piece with a mouth piece inner chamber to develop air pressure when a user blows into the mouth piece of the flute;
a flat plate attached to the mouth piece having a flat plate orifice to allow an air stream to pass through to a aft end inner chamber the air pressure of the mouth piece inner chamber creates the air stream, the air stream passes over a cutting edge of the aft end; and
a palm hole in the aft piece the aft piece attached to the flat plate, the palm hole allows the user to modify the sound of the flute.

11. The device of claim 10 wherein the mouth piece has an open end for the user to place near their mouth, the open end is generally round in shape.
